(19) United States
(12) Patent Application Publication
(10) Pub. No.: US 2010/0287351 A1
(43) Pub. Date: Nov. 11, 2010

(54) FILE ACCESS MANAGEMENT SYSTEM

(75) Inventors: David Kren, London (GB); Jaime Casas, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/666,858

(22) PCT Filed: Jun. 20, 2008
(86) PCT No.: PCT/GB08/02177

§ 371 Date: Jun. 16, 2010

(30) Foreign Application Priority Data
Jun. 28, 2007 (GB) 0712648.5

(51) Int. Cl. G06F 12/14

(52) U.S. Cl. 711/165; 711/E12.091

(57) ABSTRACT

A computing device arranged to control access by application threads to a number of data portions stored in memory on the computing device. Each thread includes a handle for each data portion for which it is arranged to access or manipulate. When an application thread includes instructions to manipulate a data portion, it calls a function. The system copies the data portion to a new memory location and applies the function which has been called to the data portion copy.

### FIELD OF THE INVENTION

The present invention relates to a computing device arranged to control access to data in a shared system. In particular, the present invention relates to a computing device system which enables applications to access data in the shared system simultaneously. The present invention also relates to a corresponding method.

### BACKGROUND OF THE INVENTION

Many modern operating systems operate a pre-emptive multithreading environment. In such an environment, multiple threads of execution can be executed in parallel. Individual threads are assigned a particular priority, so that when more threads require execution than can be handled by a particular processor, the higher priority threads are executed first. Certain threads may include instructions to read data, for example to output a bitmap to a display device. Such operations do not generally result in any re-allocation of memory and if two threads simultaneously try to read the same data, no problems result. Other threads include instructions to manipulate data by, for example, resisting or compressing a bitmap. Such threads typically call an appropriate manipulation function from a data management system. Manipulation functions typically result in a re-allocation of memory for the data being manipulated. If two threads try to manipulate the same data at the same time, memory errors will result because both threads will be trying to re-allocate memory at the same time. Furthermore, where one thread is accessing particular data and another thread calls a function to manipulate the data, similar errors will occur.

FIG. 1 demonstrates the problems associated with concurrency in a multithreading environment. A mobile telephone 100 known from the prior art is shown schematically together with a virtual global memory chunk 101. Two bitmaps 102, 103, are stored in memory 101. The mobile phone also has stored in memory a number of applications which each include one or more threads of execution. In FIG. 1, two threads of execution 104, 105 are shown. Thread 104 includes instructions to read and display bitmap 102. In use, the thread 104 is executed and the bitmap 102 is displayed in its correct form on a display of the mobile phone 100. In the absence of any concurrency control, other threads of execution are able to manipulate bitmaps in the global memory 101 while thread 104 is displaying bitmap 102. Thread 105 includes instructions to resize the bitmap 102 for display at some point in the future by another thread. In use, an application may cause thread 105 to manipulate bitmap 102 while thread 104 is displaying it on the mobile phone display. The manipulation operation results in a re-allocation of memory as can be seen in FIG. 1. The thread 105 resizes the bitmap 102 and changes its virtual memory address. The new bitmap 106 is shown with broken lines. While this is happening, the thread 104 is continuing to try and display the bitmap 102. Because thread 105 has changed the bitmap 102 and its memory allocation, the thread 104 is unable to display the original bitmap and instead displays a corrupted version of the bitmap, as can be seen in FIG. 1. This provides a poor user experience and in the absence of any mechanism for correcting the memory address referenced by thread 104, the device may become permanently corrupted.

There are several mechanisms known in the prior art for dealing with the problems associated with concurrency. A typical operating system includes a file management system which controls access to data stored in memory using a synchronisation mechanism. One such mechanism is serialisation. The file system carries out read and manipulation operations in sequence. This is time consuming because each operation must wait for earlier operations to finish before it can begin. Another mechanism is a mutual exclusion, or mutex, such as a lock. Different types of locks are known, including global locks and file locks. A global lock applies to the entire file management system for a given file type. When a thread calls a function which manipulates or otherwise causes file data to be re-allocated, the thread must first acquire the global lock. Once the thread has the global lock, only that thread can call a manipulation function.

When the thread has finished the data manipulation it replaces the global lock. Other threads must wait for the global lock to become available before they can manipulate file data. The main problem with using a global lock is that deadlocking situations can arise. Furthermore, a malicious thread can lock the file system and not unlock it. This can cause the file system to lock-up and the device to become unusable. If a malicious thread is launched at start-up, a device may never be usable. A further problem is the fact that a global lock locks the entire file system. This slows down the entire system, as threads have to take it in turn to access the file system. This defeats the whole object of a multithreading environment.

An alternative to using a global lock mechanism is to use a file lock mechanism. In such a mechanism, each individual file has a lock associated with it. Therefore, only the file data being manipulated needs to be locked. This has the advantage that file data which are not being manipulated by one thread can be manipulated by another thread. However, some of the problems associated with global locks also apply to file locks. In particular, deadlocking situations can still result and a malicious thread can lock-up particular file data, making it inaccessible to other threads.

In view of the above, it is clear that there is a need for a data management system which avoids the problems associated with using locks or other similar synchronisation mechanisms. Such a system should also be good for device performance and require minimal RAM.

### SUMMARY OF THE INVENTION

In a preferred embodiment, the present invention provides a computing device which controls access by application threads to a number of data portions stored in memory on the computing device. Each thread includes a handle for each data portion for which it is arranged to access or manipulate. When an application thread includes instructions to manipulate a data portion, it calls a function. The computing device copies the data portion to a new memory location and applies the function which has been called to the data portion copy. Each data portion includes associated metadata which is used to store information concerning the data portion. Part of the metadata can be marked with a dirty flag which indicates that the data portion has recently been copied and manipulated. When a data portion is copied in order to be manipulated, the computing device marks the original data portion with a dirty flag and stores a handle for the new data portion in the metadata of the original data portion. When an application thread subsequently accesses or manipulates a given data portion, the system first checks for the presence of a dirty flag. If a dirty flag is present, the stored handle for the new data portion is returned to the calling thread, and the thread is directed to the new data portion.

The present invention provides a computing device comprising memory arranged to store a plurality of data portions, wherein the computing device is arranged to run a plurality of processes which reference a data portion, and the computing device is further arranged to copy said data portion to a new memory location when a process attempts to manipulate that data portion, to manipulate the copy and to destroy the original data portion when a predetermined condition is met.

Thus, the computing device of the present invention enables different threads to access different data portions at the same time. When one thread manipulates a data portion, the entire system remains available to other threads as no locks are used. Furthermore, if one thread tries to read a data portion at the same time that another thread tries to manipulate that data portion, no errors occur because the file handle remains valid, even before a dirty flag has been applied to the metadata associated with the original data portion. There is also no security risk because no one application can lock-up the entire system. Because locks are not used, the system cannot run into deadlock situations. There is also an improvement in device performance and speed because multiple threads can access and manipulate data in the system at the same time. The device also provides increased effective memory when compared with a device in which old data portions are not deleted, or are deleted after a long period of time.

Preferably, the data portions are image data, or other data having content which is conveyable to a user via a device display. With such data, the present invention provides the advantage that the correct, non-corrupted image, is always shown to the user. This provides for an enhanced user experience.

Preferably, once the application process has manipulated the copied data portion, any processes which attempt to access the old data portion are updated to reference the new data portion. The predetermined condition is preferably met when all the application processes reference the new data portion. In this manner, the present invention provides a particularly efficient device which only retains bitmaps in memory for as long as required. This further enhances the effective memory of the device.

The present invention also provides a computing device comprising memory arranged to store a plurality of data portions, wherein the computing device is arranged to run a plurality of processes which reference said data portion, and the computing device is further arranged to copy said data portion to a new memory location when a process attempts to manipulate that data portion, to manipulate the copy and to mark data associated with the original data portion, to indicate it has been replaced by said copy.

The present invention also provides a method of managing data access in a computing device memory, the memory arranged to store a plurality of data portions and the computing device arranged to run a plurality of processes which reference a data portion, wherein, when a process attempts to manipulate said data portion, a copy of said data portion is made, the copy is manipulated, and the original data portion is destroyed when a predetermined condition is met.

The present invention also provides a method of managing file access in computing device memory, the memory arranged to store a plurality of data portions and the computing device arranged to run a plurality of processes which reference a data portion, wherein, when a process attempts to manipulate a data portion, a copy of said data portion is made, the copy is manipulated, and data associated with said original data portion is marked to indicate it has been replaced by said copy.

The present invention also provides a computing device comprising: memory arranged to store a plurality of data portions and a plurality of applications each arranged to access or manipulate said plurality of data portions; a user input arranged to allow a user to control the plurality of applications; a display arranged to display a viewable output of said plurality of applications; a data management server arranged to control access by said applications to said data portions; wherein requests by said applications to manipulate said data portions are routed through said data management server, and said server is arranged, following receipt of a manipulation request, to copy a relevant data portion, and perform the manipulation request on said copy.

Preferably, the memory comprises a plurality of different memory units, each arranged to store different applications and data portions. In particular, the memory may include ROM (read only memory), which stores the operating system code, a user data memory which stores user data and some applications, and RAM (read only memory) into which applications and file date are loaded when in use.

The term “reference” is intended to mean the relationship between an application process and a file, by means of which the application process is able to read or manipulate the file. For example, an application process may read a file in order to display its contents to a user via a display. Furthermore, an application process may manipulate a file by resizing it, changing its resolution, compressing it, amongst other manipulation processes. An application process which is arranged to read or manipulate a file in this way is said to reference that file.

Other features of the present invention are defined in the appended claims. Features and advantages associated with the present invention will be apparent from the following description of the preferred embodiments.

### BRIEF DESCRIPTION OF THE DRAWINGS

The present invention will now be described by way of example only and with reference to the accompanying drawings in which:—

FIG. 1 shows a mobile telephone known from the prior art;

FIG. 2 shows a mobile telephone in accordance with an embodiment of the present invention;

FIG. 3 shows an operating system of the mobile telephone of FIG. 2;

FIG. 4 shows a multimedia and graphics services section of the operating system of FIG. 3;

FIG. 5 is a system diagram showing the various elements of the operating system, applications, file data and hardware in accordance with an embodiment of the present invention;

FIG. 6 shows a bitmap memory in accordance with an embodiment of the present invention;

FIG. 7 is a flow diagram showing an operation of the mobile telephone shown in FIG. 2;

FIG. 8 is a flow diagram showing a further operation mobile telephone shown in FIG. 2; and

FIG. 9 shows the mobile telephone of FIG. 2 in use.

### DESCRIPTION OF THE EMBODIMENTS

A preferred embodiment of the present invention will now be described in relation to an operating system arranged to run on a mobile telephone. The mobile telephone to be described shares many of its components with mobile telephones known from the prior art. In particular, the mobile telephone includes subsystems arranged to handle telephony functions, application functions (including operating system (OS) services), radio frequency (R.F.) communication services, and power regulation. The operation of these common components will be familiar to the person skilled in the art. These subsystems have not be shown, or described, except where an understanding of their structure or operation is required in order for the present invention to be understood.

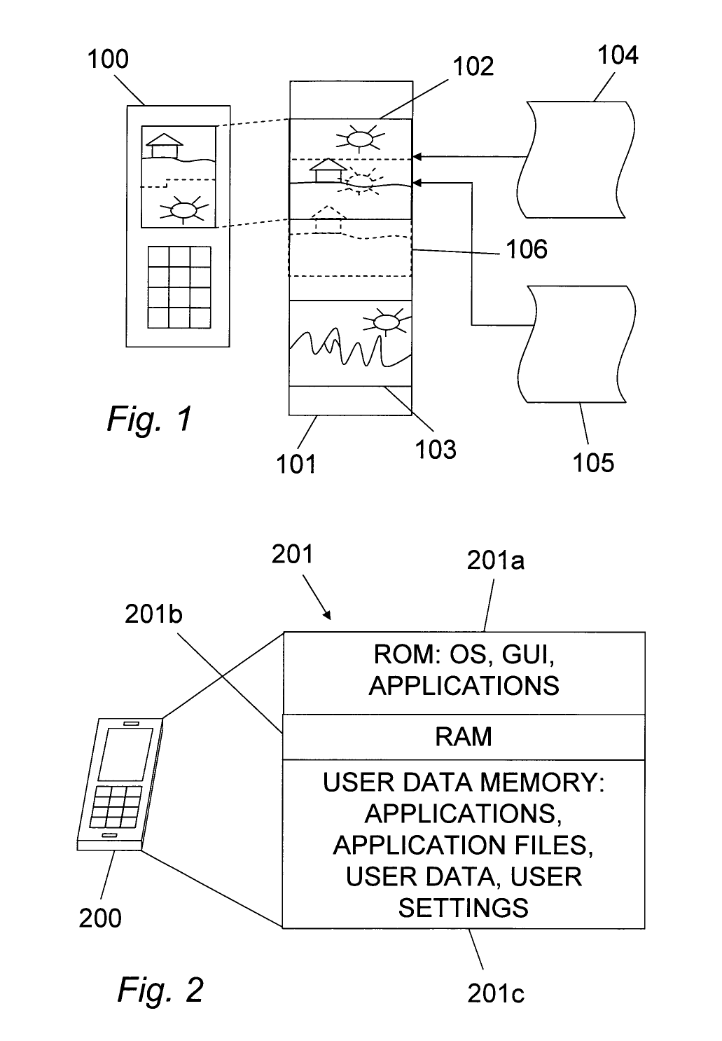

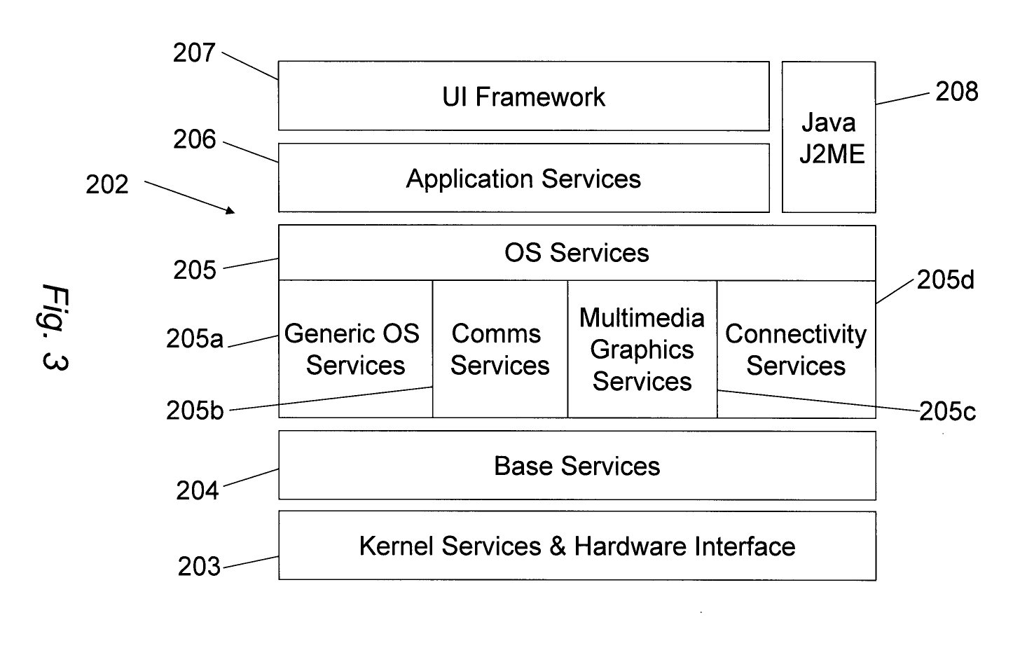

FIG. 2 shows a mobile telephone 200. The mobile telephone 200 includes memory 201 which is shown schematically in FIG. 2. The memory includes three separate memory components. These components are read only memory (ROM) 201a, random access memory (RAM) 201b and user data memory 201C. The ROM 201a includes an operating system, graphical user interface and other critical applications. The RAM 201b is a volatile memory which is inherently empty when the mobile telephone is switched off. Applications are loaded into RAM 201b, as required, when the mobile telephone is switched on. The user data memory 201c includes other applications, application files, user data and user settings.

The operating system mentioned above in connection with the ROM 201a, also shares many of its elements with mobile telephone operating systems known from the prior art. The operating system in accordance with the preferred embodiment of the present invention will be described briefly in connection with FIG. 3.

FIG. 3 shows a system model for the operating system 202, which is stored in ROM 201a of mobile telephone 200. The operating system 202 includes various layers, each arranged to carry out the functions of the operating system.

The operating system 202 includes three main sections, namely the base section, the middleware section and the application section. The base section includes kernel services 203 and base services 204. These layers are arranged to manage the mobile telephone hardware resources and communications between hardware and the middleware of the operating system 202. The middleware is the core of the operating system 202 services and controls communication between the applications running on the device and the system resources (themselves managed by the base section). It consists of the operating system services layer 205, which is broken down into four subsections. These subsections are a generic OS services section 205a, a communications services section 205b, a multimedia and graphic services section 205c and a connectivity services section 205d. The generic OS services section 205a, communications services section 205b and a connectivity services section 205d are arranged to operate in the manner familiar to the person skilled to the person skilled in the art. The details of these sections will not be described here. The multimedia and graphic services section 205c, in accordance with the preferred embodiment of the present invention, will be described in more detail below. The application section of operating system 202 includes an application services layer 206, a user interface (UI) framework layer 207 and a Java J2ME layer 208. These layers operate in the manner familiar to the person skilled in the art.

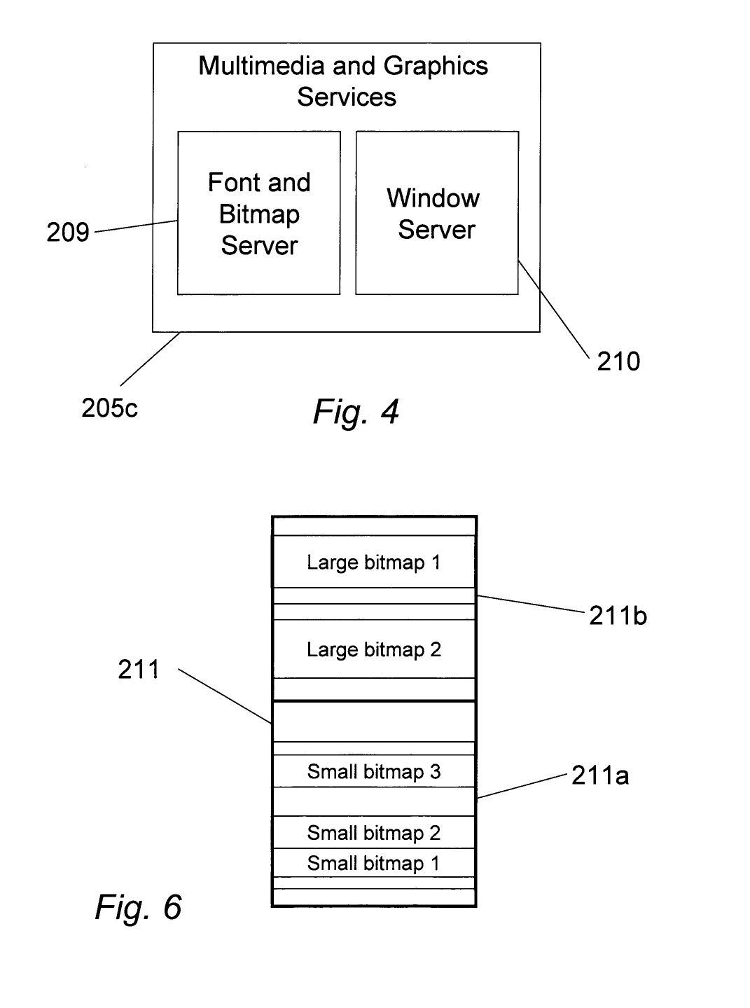

Referring to FIG. 4, the multimedia and graphic services section 205c includes a font and bitmap server (FBS) 209 and a window server 210. The font and bitmap server 209 provides a bitmap management service which manages access to bitmaps stored in the ROM 201a or in files in user data memory 201c. The font and bitmap server 209 keeps a record of all bitmaps stored in memory 201 and makes all bitmaps available to all graphics applications and to the window server 209. The function of the font and bitmap server 209 will be described in more detail below. The window server 210 provides user visible outputs to a screen of the mobile telephone 200. When an application needs to display a bitmap, the application provides the window server with a pointer to the location of the relevant bitmap so that the bitmap can be displayed.

Applications, whether based in the OS service layer 205 or the application layer 206, each comprise a number of threads of execution. When an application is running, it is the individual threads which include instructions to access or manipulate bitmaps. Hereinafter, these threads will be referred to as client threads. Client threads include handles to the virtual memory addresses of the bitmaps referenced by those client threads. These handles are maintained by the font and bitmap server 209. When a client thread requires access to a bitmap, for reading or manipulation, the font and bitmap server controls that access. When a bitmap needs to be displayed on the screen of mobile telephone 200, a client thread will pass the handle of the relevant bitmap to the window server 210 so that the window server can display the appropriate bitmap.

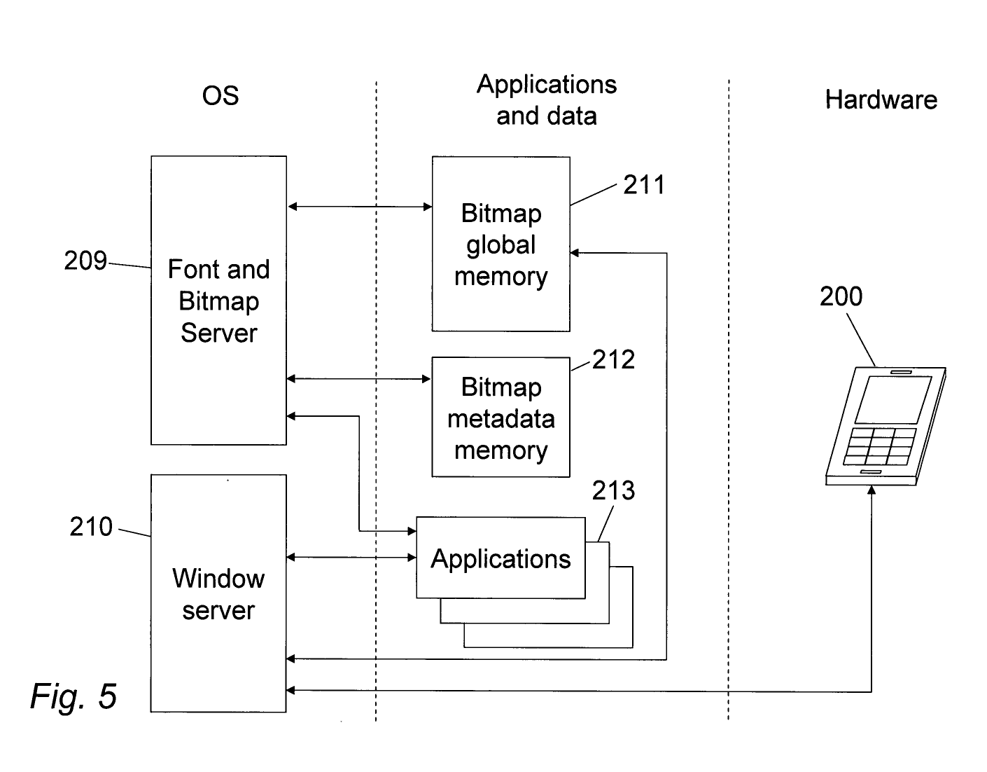

FIG. 5 shows the architecture of the overall, bitmap management system which includes operating system components, applications, data and hardware. The font and bitmap server 209 stores the available bitmaps in global memory 211. All bitmaps include associated metadata. The metadata includes information about a bitmap, such as file size and image resolution. All bitmap metadata is stored separately to the global memory 211 in a separate metadata memory 212. The metadata also includes data relating to bitmap access control. As will be described below, when a manipulation function is called, the bitmap is copied to a new location. The old bitmap, in most cases, is not deleted. Instead, the old bitmap is marked with a dirty flag, which indicates to any client threads which subsequently require access to the bitmap, that a new bitmap has been created. A bit in the bitmap metadata is reserved for the dirty flag.

The bitmaps stored in the global memory 211 are accessible by a plurality of applications 213. As noted above, each application includes one or more client threads. A client thread may require access to a bitmap either to read the bitmap, for example to display the bitmap on the screen of the mobile device, or to manipulate the bitmap. The font and bitmap server 209 includes various functions which can be called by client threads to manipulate bitmap data.

These functions include a resize function and a compress function, amongst others. These functions each require a re-allocation of memory due to the increase or decrease in the size of the bitmap. The font and bitmap server 209 controls access to bitmaps for all purposes, as noted above.

The virtual address range reserved for the global memory 211 is divided into two sections, as seen in FIG. 6. The first section is a small bitmap section 211a and the second section is a large bitmap section 211b. The diagonally shaded areas are virtual pages which are committed to physical memory. As can be seen in FIG. 6, the small bitmap section 211a includes a contiguous set of pages which are committed to physical memory and which can grow and shrink in the same way as a normal single-ended memory heap. The large bitmap section 211b commits pages to physical memory bitmap by bitmap. A page only holds data for one large bitmap, and when a large bitmap is deleted, the set of pages it used is de-committed from physical memory. Because large bitmaps are allocated an integer number of physical memory pages, bitmap sizes are generally rounded up to integer multiples of the page size. Memory is wasted if the size of a large bitmap is not exactly an integer multiple of the page size. To reduce this waste of memory, large bitmaps have to be considerably bigger than the memory page size. In the preferred embodiment, a large bitmap is one which is four times the size of a page. Therefore, for a 4 KB page, a large bitmap is at least 16 KB. All other bitmaps are treated as small bitmaps.

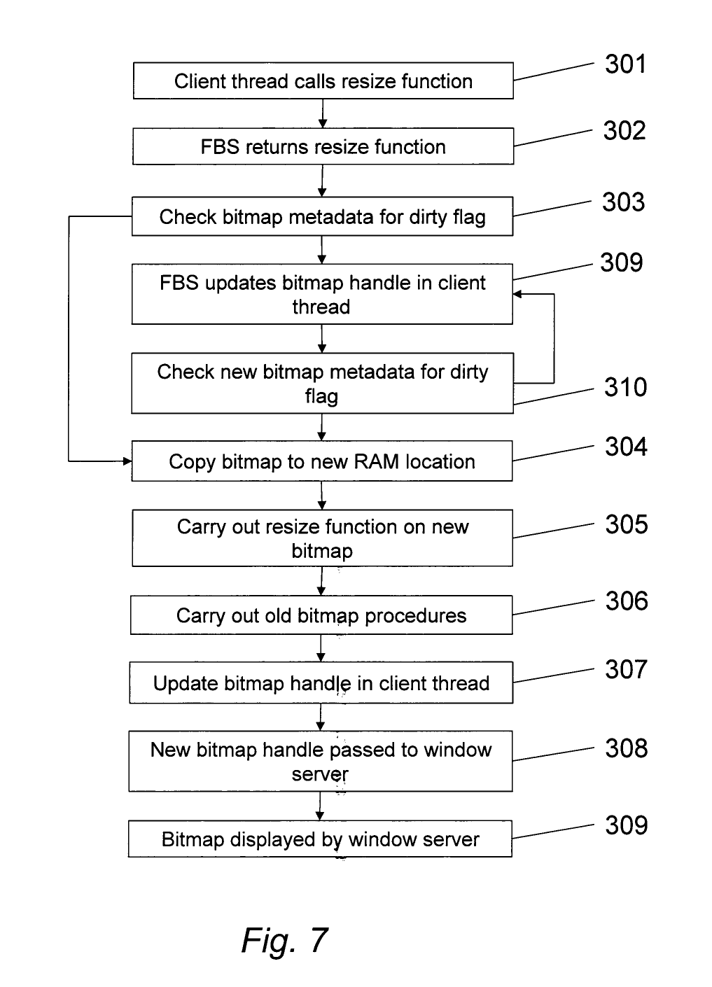

The size of the virtual address range reserved for the global memory chunk 211 is calculated when the device is switched on. Typically the virtual address range is set to be the amount of physical RAM made available to the font and bitmap server 209 to the power of two. The size of the virtual address range is also set to be between a predetermined maximum and minimum. The process of bitmap manipulation will now be described in more detail in connection with FIG. 7.

The manipulation process will be described in the context of a bitmap resize operation. The process is initiated when an application is required to resize and display a particular bitmap. A client thread calls a resize function from the font and bitmap server 209 (step 301). The client thread includes a handle for the relevant bitmap which is in the form of a pointer to the virtual memory address space for that bitmap. This handle is passed to the font and bitmap server 209 as part of the calling process. The font and bitmap server 209 then returns the resize function which includes the handle to the relevant bitmap (step 302).

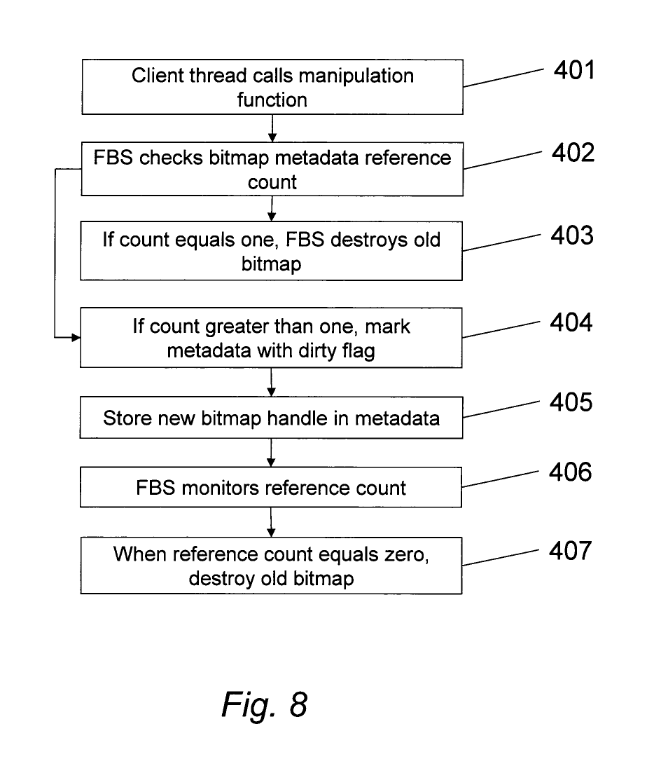

Before carrying out the resize function, the font and bitmap server 209 checks the metadata associated with the bitmap concerned for the presence of a dirty flag (step 303). If no dirty flag is present, the font and bitmap server 209 copies the bitmap to a new location in RAM 201b (step 304). Once the bitmap has been copied to the new location, the font and bitmap server 107 carries out the resize function on the new bitmap (step 305). The font and bitmap server 209 then carries out procedures for dealing with the old bitmap (step 306). These procedures will be explained in more detail below in relation to FIG. 8. So that the bitmap manipulation process can be clearly understood, the basic aspects of the procedures for dealing with old bitmaps will briefly be described. Each bitmap includes a reference count which is stored in the metadata associated with that bitmap. Where more than one client thread reference a particular bitmap the reference count for that bitmap will be greater than one. In these circumstances, the font and bitmap server 209 marks the bitmap metadata with a dirty flag and stores a handle to the new bitmap in the old bitmap metadata. Therefore, when another client thread subsequently tries to access the old bitmap, the new bitmap handle is passed to the client thread which can then locate the new bitmap.

Returning to FIG. 7, once the resize function has been carried out on the new bitmap the client thread which called the resize function is updated with the handle for the new bitmap (step 307). The new bitmap may then be displayed by the application whose client thread called the resize function. The new bitmap handle is passed by the client thread to the window server (step 308). The new bitmap is then displayed by the window server (step 309).

At step 303, if the font and bitmap server 209 detects a dirty flag in the metadata of the bitmap being operated on, this indicates that the bitmap is old and that it has been replaced by a new bitmap. The font and bitmap server 209 retrieves the new bitmap handle from the metadata associated with the bitmap in question and updates the bitmap handle in the client thread which called the resize function (step 309). Before the font and bitmap server 209 can carry out the resize function on the new bitmap, it must first check to see whether or not the new bitmap has itself been manipulated and is therefore now an old bitmap (step 310). This is achieved by checking the metadata associated with the new bitmap for a dirty flag. If no dirty flag is present in the metadata of the new bitmap, the process can proceed to step 304 and the resize function can be carried out in the manner described above in connection with steps 304 to 309. If the metadata associated with the new bitmap does contain a dirty flag, the process returns to step 309, and the font and bitmap server updates the bitmap handle in the client thread which called the resize function. Steps 309 and 310 are repeated until a bitmap is located which does not include a dirty flag in its associated metadata.

The procedure for dealing with old bitmaps will now be described in more detail in connection with FIG. 8. The process begins when a client thread calls a manipulation function (step 401). Whenever a client thread calls a manipulation function, the font and bitmap server 209 copies the bitmap data to a new location, leaving the old bitmap in memory. The metadata associated with each bitmap includes a reference count. The reference count provides an indication of the number of client threads which include a handle directed to that particular bitmap. Once a bitmap has been copied, the first step carried out by the font and bitmap server 209 is to check the reference count stored in metadata for that particular bitmap (step 402). If the reference count for that particular bitmap is one, the font and bitmap server 209 knows that only the client thread which has just called the manipulation function references that particular bitmap. Because the handle stored by the client thread for that particular bitmap will have been updated in accordance with the process described in connection with FIG. 7, the font and bitmap server 209 can destroy the old bitmap immediately as it knows that no client threads refer to that particular bitmap any longer (step 403).

If the reference count for that particular bitmap is greater than one, the font and bitmap server 209 knows that other client threads may subsequently try to access that particular bitmap. The font and bitmap server 209 therefore marks the metadata associated with that particular bitmap with a dirty flag (step 404). In addition to this, the font and bitmap server stores a handle to the newly created bitmap in the metadata of the old bitmap (step 405). Consequently, any thread subsequently accessing the old bitmap will be directed to the new bitmap. The font and bitmap server 209 then monitors the reference count for the old bitmap by checking the reference count every time a new client thread attempts to access the old bitmap (step 406). When the reference count for that bitmap equals zero the old bitmap is destroyed by the font and bitmap server 209 (step 407).

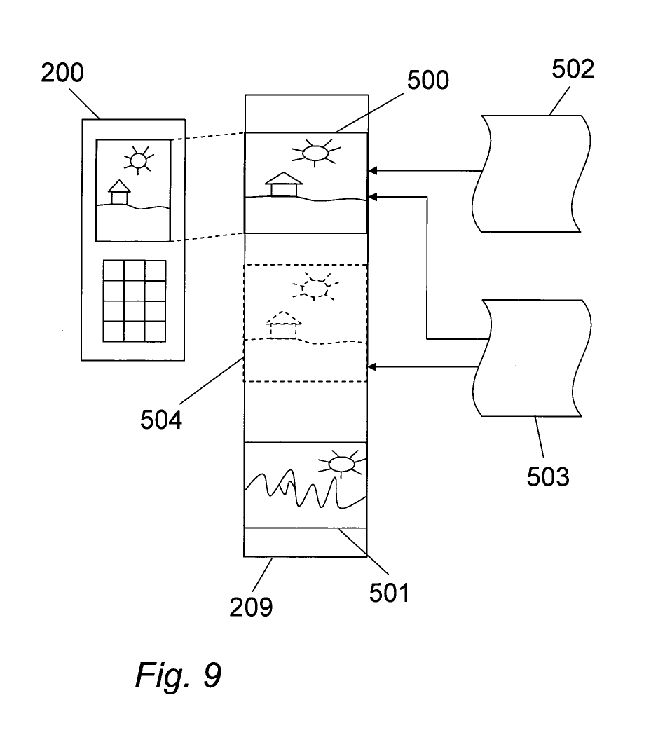

Some of the advantages of the present invention will now be described in connection with FIG. 9. FIG. 9 shows the mobile telephone 200 schematically together with global memory 211. The global memory 211 includes two bitmap files 500 and 501. As noted above, the mobile telephone includes a number of applications, stored in memory, each of which includes at least one thread of execution. In FIG. 9, two threads 502, 503 are shown. Thread 502 includes instructions to read and display bitmap 500 on the display of mobile telephone 200. Thread 503 includes instructions to resize bitmap 500. In use, thread 503 requests a resize function from the font and bitmap server 209. The font and bitmap server then copies the bitmap 500 to a new location in memory 211 to form new bitmap 504. The font and bitmap server 209 then performs the resize function on new bitmap 504. This means that if a bitmap is being read by one thread, it cannot be simultaneously manipulated by another thread. In FIG. 9, the thread 502 is shown reading and displaying bitmap 500. Thread 503 calls a resize function from the font and bitmap server 209 which then copies the original bitmap 500, and produces new bitmap 504. In this manner, thread 502 can continue to read and display bitmap 500 without any risk of the data being corrupted, as shown in FIG. 9. This situation can be compared to that shown in FIG. 1. FIG. 1 shows a mobile phone known from the prior art in which no concurrency provisions exist. As can be seen, a corrupted image is shown to the user. In the present case, the image presented to the user is not corrupted and the user does not experience any problems in the use of files which form part of the mobile telephone's file system. This results in a greatly improved user experience.

Although the present invention has been described in the context of a software based font and bitmap server, the font and bitmap server may be implemented as hardware. In particular, the font and bitmap server may take the form of a physical server, implemented on a microchip, which can be located in the application subsystem of the mobile telephone 200. Such an arrangement will not suffer from performance degradation which may occur in a resource limited device such a mobile telephone.

The present invention has been described in connection with a bitmap management service. The present invention also applies to management systems for other data types. Any system in which data needs to be shared among threads of execution can benefit from the present invention. In particular, where data must remain available to all threads which reference that data, and where certain thread operations make data inaccessible, the present invention is particularly advantageous.

It will be appreciated by the skilled person that read and manipulation operations are carried out on bitmaps which are loaded in memory. In other words, the operations are carried out on raw bitmap data, loaded in RAM, while the computing device is in operation. Prior to any such operations being carried out, the bitmap data is loaded, out of a file in which it may be permanently stored, and in to temporary memory storage. The present invention does not, therefore, operate on data stored in files in persistent storage. Bitmap data may be stored on a persistent basis in a bitmap file, or on a temporary basis in RAM. Bitmap data stored in RAM may be referred to as a data portion in the context of the present invention. The mechanism of the present invention is arranged to operate on data portions stored in RAM, rather than files stored in a persistent store.

The present invention is based, in part, on the realisation that locks are overly burdensome on device resources. Although the present invention has been described in the context of a particular system, it will be understood by the skilled person that other systems could be used which employ the benefits of the present invention. In particular, in its broadest sense, the present invention provides a method of managing concurrency in memory which does not use locks. The above described prior art systems use locks to manage concurrency. In effect, the prior art does not allow concurrency as locks reschedule threads so that they each have to wait for the previous thread to finish before they can be executed. The present invention actually allows concurrency by avoiding the use of locks.

In addition, further modifications, additions and variations to the above described embodiments will be apparent to the intended reader being a person skilled in the art, to provide further embodiments which incorporate the inventive concept of the present invention, and which fall within the scope of the appended claims.

1. A computing device comprising:
memory configured to store a plurality of data portions, wherein the computing device is configured to run a plurality of processes referencing a data portion, and the computing device is further configured to copy said the data portion to a new memory location if a process attempts to manipulate the data portion, to manipulate the copy and to destroy the original data portion when a predetermined condition is met.

2. A computing device according to claim 1, wherein the predetermined condition is met if none of the plurality of processes is referencing the original data portion.

3-45. (canceled)

46. A computing device according to claim 1, wherein data associated with the original data portion is marked to indicate that the data portion has been copied if the computing device copies a data portion.

47. A computing device according to claim 46, wherein the computing device is further configured to store a pointer to the memory location of the copy of the data portion in the data associated with the original data portion if the computing device copies the data portion.

48. A computing device according to claim 46, wherein the computing device is further configured to:
check the data associated with the original data portion, for a mark, before copying the data portion; and
manipulate the copy of the data portion, if the mark does not exist.

49. A computing device comprising:
memory configured to store a plurality of data portions, wherein the computing device is configured to run a plurality of processes referencing a data portion, and the computing device is further configured to copy the data portion to a new memory location if a process attempts to manipulate the data portion, to manipulate the copy and to mark data associated with the original data portion, to indicate the original data portion has been replaced by the copy.

50. A computing device according to claim 49, wherein the computing device is further configured to store a pointer to the location of the copy of the data portion in the data associated with the original data portion if the computing device copies the data portion.

51. A computing device according to claim 49, wherein the computing device is further configured to:
check data associated with the data portion, for a mark, before copying the data portion; and
locate the copy of the data portion and process the copy of the data portion, if the mark exist.

52. A computing device according to claim 49, wherein the computing device is further configured to manipulate the copy, once the copy of the data portion has been made.

53. A computing device according to claim 52, wherein the computing device is further configured to destroy the original data portion if none of the plurality of processes is referencing the original data portion.

54. A method of managing data access in a computing device memory, the memory configured to store a plurality of data portions, the method comprising:
running a plurality of processes referencing a data portion;
copying the data portion if a process attempts to manipulate the data portion;
manipulating the copy of the data portion; and
destroying the original data portion if a predetermined condition is met.

55. A method according to claim 54 further comprising counting references to the data portion by the plurality of processes, the predetermined condition being met if the reference count equals zero.

56. A method according to claim 54 further comprising marking data associated with the data portion to indicate the data portion has been copied.

57. A method according to claim 56 further comprising storing a pointer to the location of the copy in the data associated with the original data portion.

58. A method according to claim 56 further comprising:
checking the data associated with the data portion, for a mark, before copying the data portion; and
manipulating the copy of the data portion, if the mark does not exist.

59. A method of managing file access in computing device memory, the memory configured to store a plurality of data portions, the method comprising:
running a plurality of processes referencing a data portion;
copying the data portion if a process attempts to manipulate the data portion;
manipulating the copy of the data portion; and
marking data associated with the original data portion to indicate that the original data portion has been replaced by the copy.

60. A method according to claim 59 further comprising storing a pointer to the location of the copy of the data portion in the data associated with the original data portion.

61. A method according to claims 60, further comprising:
checking the data associated with the data portion, for a mark, before copying the data portion; and
manipulating the copy of the data portion, if the mark does not exist.

62. A method according to claim 59 further comprising destroying the original data portion if none of the plurality of processes is referencing the original data portion.

63. A computing device comprising:
memory configured to store a plurality of data portions and a plurality of applications each configured to access or manipulate the plurality of data portions;
an input module configured to allow a user to control the plurality of applications;
a display configured to display a viewable output of the plurality of applications; and
a data management server configured to:
control access requests, made by the applications, to manipulate the data portions;
copy a relevant data portion, if an access request is to manipulate the relevant data portion; and
perform the manipulation request on the copy of the relevant data portion
